(19) United States
(12) Patent Application Publication
(10) Pub. No.: US 2025/0250776 A1
(43) Pub. Date: Aug. 7, 2025

(54) DISPLAY CONTROL DEVICE, WORK MACHINE, AND DISPLAY CONTROL METHOD

(71) Applicant: Komatsu Ltd., Tokyo (JP)

(72) Inventors: Ryohei Hasegawa, Tokyo (JP); Jungo Moriyasu, Tokyo (JP)

(73) Assignee: Komatsu Ltd., Tokyo (JP)

(21) Appl. No.: 18/856,920

(22) PCT Filed: Aug. 29, 2023
(86) PCT No.: PCT/JP2023/031205

§ 371 Date: Oct. 15, 2024

(30) Foreign Application Priority Data
Sep. 2, 2022 (JP) 2022-139847

(51) Int. Cl. E02F 9/26; E02F 9/20

(52) U.S. Cl. CPC E02F 9/264; E02F 9/2012; E02F 9/262

(57) ABSTRACT

One aspect of the present disclosure provides a display control device including a storage unit configured to store a plurality of group regions and one or more pieces of item information displayed in each of the plurality of group regions, a mode switching unit configured to enable switching of an operation mode a display region based on an operation input from an operation input unit, and a display control unit configured to control information to be displayed in the display region based on the switched operation mode, in which the mode switching unit enables switching between a focus operation mode in which one of the plurality of group regions is selectable and a mouse operation mode in which a direct operation is possible on the display region.

### TECHNICAL FIELD

The present disclosure relates to a display control device, a work machine, and a display control method.

Priority is claimed on Japanese Patent Application No. 2022-139847, filed Sep. 2, 2022, the content of which is incorporated herein by reference.

### BACKGROUND ART

A control device attached to a driver's seat of a work machine to assist an operation of an operator by displaying a state of the work machine is known. The control device displays, on a monitor, a plurality of types of display screens that display information necessary for assisting an operation of the work machine. A so-called touch panel type monitor is also employed for such a monitor.

A control device described in Patent Document 1 discloses a configuration in which a display screen displayed on a touch panel monitor receives a touch operation, and control is performed in response to the touch operation.

### CITATION LIST

### Patent Document

Patent Document 1: Japanese Unexamined Patent Application, First Publication No. 2021-56816

### SUMMARY OF INVENTION

### Technical Problem

In the control device described in Patent Document 1, when an operator operates the control device, the operator needs to touch a monitor screen of a touch panel with a finger to operate the control device. In a case where functions of the control device are diverse, a large number of icons or the like associated with the respective functions may be displayed in a display region of the monitor screen. In such a case, it may be difficult for the operator to select the desired icon from among the large number of icons or the like by touching the display screen of the touch panel monitor.

In addition, a steering wheel, a switch, a lever, and the like for operating each part of a work machine are provided in a driver's seat of the work machine within a reachable range from the operator who is seated on the driver's seat. Therefore, as a result of disposing the touch panel monitor so as to avoid the steering wheel, switch, lever, and the like, there is a possibility that a physical load is applied to the operator when operating the touch panel monitor.

The present disclosure has been made in consideration of the above-mentioned circumstances, and an object of the present disclosure is to provide a display control device, a work machine, and a display control method that can improve operability and reduce a load on an operator.

### Solution to Problem

In order to solve the above problems, according to an aspect of the present disclosure, a display control device is provided that displays information related to a work machine in a display region of a monitor provided in the work machine, the display control device including a storage unit configured to store a plurality of group regions set by dividing the display region and one or more pieces of item information displayed in each of the plurality of group regions and in which a predetermined function is assigned, an input receiving unit configured to receive an operation input from an operation input unit provided in a driver's seat of the work machine, a mode switching unit configured to enable switching of an operation mode on the display region based on the operation input from the operation input unit received by the input receiving unit, and a display control unit configured to control information to be displayed in the display region according to the operation input that is input to the input receiving unit based on the operation mode switched by the mode switching unit, in which the mode switching unit enables switching between a focus operation mode in which one of the plurality of group regions is selectable and a mouse operation mode in which a direct operation is possible on the display region.

### Advantageous Effects of Invention

According to each aspect of the present disclosure, it is possible to improve operability and reduce a load on an operator.

### BRIEF DESCRIPTION OF DRAWINGS

FIG. 1 is a diagram showing an overall configuration of a work machine according to an embodiment of the present disclosure.

FIG. 2 is a diagram showing a configuration of a cab of the work machine according to the embodiment of the present disclosure.

FIG. 3 is a diagram showing an appearance of a jog dial according to the embodiment of the present disclosure.

FIG. 4 is a diagram showing a hardware configuration of a display control device according to the embodiment of the present disclosure.

FIG. 5 is a diagram showing a functional configuration of the display control device according to the embodiment of the present disclosure.

FIG. 6 is a diagram showing an example of a guidance screen displayed in a display region of a monitor according to the embodiment of the present disclosure.

FIG. 7 is a diagram schematically showing transition of an operation mode in the display control device according to the embodiment of the present disclosure.

FIG. 8 is a diagram schematically showing transition of a selection state of a group region in the display control device according to the embodiment of the present disclosure.

FIG. 9 is a diagram schematically showing transition of selection states of a plurality of icons in the display control device according to the embodiment of the present disclosure.

FIG. 10 is a diagram schematically showing transition of a display state of a view image in the display control device according to the embodiment of the present disclosure.

FIG. 11 is a diagram showing the guidance screen in a mouse operation mode in the display control device according to the embodiment of the present disclosure.

FIG. 12 is a diagram showing a processing flow of the display control device according to the embodiment of the present disclosure.

### DESCRIPTION OF EMBODIMENTS

Hereinafter, an embodiment of the present disclosure will be described with reference to the drawings. In each drawing, the same reference numerals are used for the same or corresponding configurations, and the description thereof will be omitted as appropriate.

### (Structure of Work Machine)

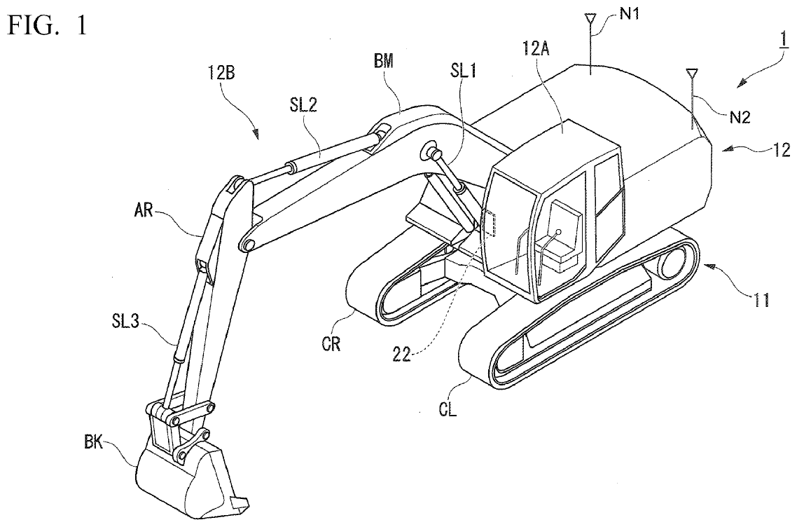

FIG. 1 is a diagram showing a structure of a work machine according to an embodiment of the present disclosure.

A work machine 1, which is a hydraulic excavator, excavates and levels earth or the like at a work site or the like. As shown in FIG. 1, the work machine 1, which is a hydraulic excavator, has an undercarriage 11 for traveling, and an upper swing body 12 which is installed at an upper portion of the undercarriage 11 and is capable of swinging around an axis in a vertical direction. Further, the upper swing body 12 is provided with a cab 12A, work equipment 12B, and two GNSS antennas N1 and N2.

The undercarriage 11 has a left crawler track CL and a right crawler track CR. The work machine 1 moves forward, swings, and moves backward via the rotation of the left crawler track CL and the right crawler track CR.

The cab 12A is a place where an operator of the work machine 1 gets on to perform operation and steering. The cab 12A is installed, for example, on a left side part of a front end portion of the upper swing body 12. A monitor 22 is mounted in the cab 12A of the work machine 1.

The work equipment 12B includes a boom BM, an arm AR, and a bucket BK. The boom BM is mounted on the front end portion of the upper swing body 12. In addition, the arm AR is attached to the boom BM. In addition, the bucket BK is attached to the arm AR.

In addition, a boom cylinder SL1 is attached between the upper swing body 12 and the boom BM. The boom BM can be operated with respect to the upper swing body 12 by driving the boom cylinder SL1. An arm cylinder SL2 is attached between the boom BM and the arm AR. The arm AR can operate with respect to the boom BM by driving the arm cylinder SL2. A bucket cylinder SL3 is attached between the arm AR and the bucket BK. The bucket BK can operate with respect to the arm AR by driving the bucket cylinder SL3.

The upper swing body 12, the boom BM, the arm AR, and the bucket BK which are included in the work machine 1, which is a hydraulic excavator, are one aspect of a movable part of the work machine 1.

The work machine 1 according to the present embodiment has been described to include the foregoing configuration, but in other embodiments, the work machine 1 does not necessarily include all of the foregoing configuration. For example, the work machine 1 according to other embodiments does not have to include the GNSS antennas N1 and N2.

### (Configuration of Cab)

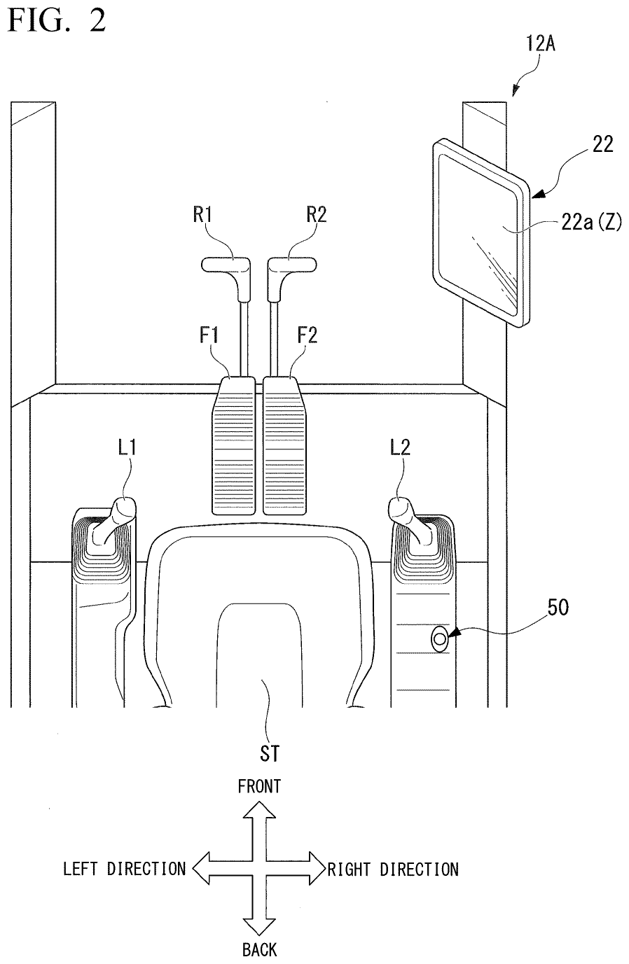

FIG. 2 is a diagram showing a configuration of a cab of the work machine according to the embodiment of the present disclosure.

As shown in FIG. 2, the cab 12A is provided with operating levers L1 and L2, foot pedals F1 and F2, and traveling levers R1 and R2.

The operating lever L1 and the operating lever L2 are respectively disposed at left and right sides of a driver's seat ST in the cab 12A. In addition, the foot pedal F1 and the foot pedal F2 are disposed on a floor surface in front of the seat ST in the cab 12A.

The operating lever L1 disposed on the left side when facing the front of the cab is an operating mechanism for performing a swing operation of the upper swing body 12 and an excavating and dumping operation of the arm AR. In addition, the operating lever L2 disposed at the right side when facing the front of the cab is an operating mechanism for performing an excavating and dumping operation of the bucket BK and a raising and lowering operation of the boom BM.

Further, the traveling levers R1 and R2 are operating mechanisms for performing operation control of the undercarriage 11, that is, traveling control of the work machine 1. The traveling lever R1 disposed at the left side when facing the front of the cab corresponds to a rotational drive of the left crawler track CL of the undercarriage 11.

The traveling lever R2 disposed at the right side when facing the front of the cab corresponds to a rotational drive of the right crawler track CR of the undercarriage 11.

The foot pedals F1 and F2 are each interlocked with the traveling levers R1 and R2 to perform traveling control via the foot pedals F1 and F2.

The monitor 22 is installed, for example, at a front right side when facing the front of the cab. The monitor 22, which is a display panel capable of visibly displaying information, is, for example, a liquid crystal display, an organic EL display, or the like. The monitor 22 is a touch panel type and is an input device capable of recognizing the position on a display region 22a touched by the operator when the operator touches the display region 22a of the monitor 22 with a finger.

The monitor 22 displays a guidance screen Z related to the work machine 1 in the display region 22a. The monitor 22 assists the operation of the work machine 1 via the operator by, for example, displaying the state of the work machine 1 on the guidance screen Z.

The monitor 22 displays various types of information related to the work machine 1 on the guidance screen Z. The display content of the guidance screen Z displayed on the monitor 22 is controlled by a display control device 2, which will be described later.

In addition, a jog dial 50, which is an operation input unit, is disposed in the cab 12A. The jog dial 50 is a device that performs an operation input for the guidance screen Z displayed on the monitor 22. The jog dial 50 is disposed at a position closer to the operator than the monitor 22 so that the operator can easily operate the jog dial 50. The jog dial 50 is disposed, for example, in the vicinity of the operating lever L2. The position of the jog dial 50 can be changed as appropriate.

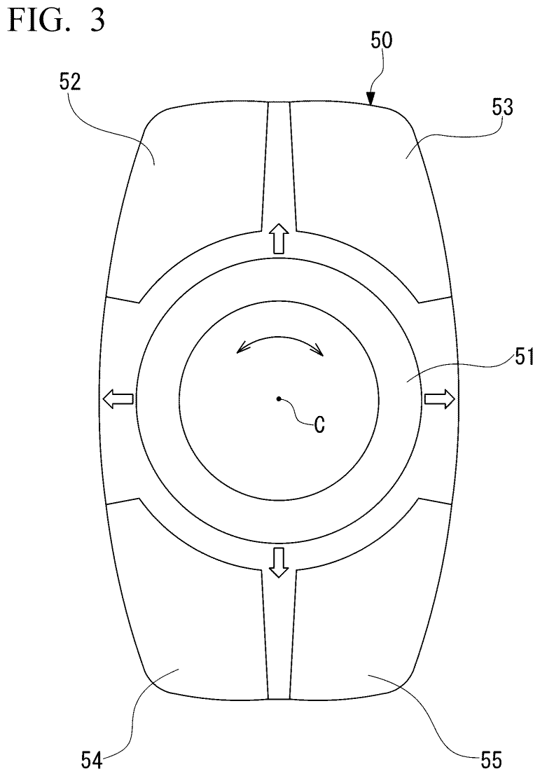

FIG. 3 is a diagram showing an appearance of a jog dial according to the embodiment of the present disclosure.

As shown in FIG. 3, the jog dial 50 includes a dial 51 and a first button 52 to a fourth button 55. The dial 51 has a circular shape when viewed from above, for example. The dial 51 can be rotationally operated about a central axis C extending in the up-down direction (direction orthogonal to the paper surface in FIG. 3). In addition, the dial 51 can be tilted forward, backward, leftward, and rightward with respect to the central axis C. The dial 51 can be pressed along the central axis C in the up-down direction. A joystick may be provided instead of the dial 51.

The first button 52 to the fourth button 55 are disposed around the dial 51. Each of the first button 52 to the fourth button 55 can be pressed in the up-down direction.

The jog dial 50 receives the operation input of the dial 51 and the first button 52 to the fourth button 55 via the operator's finger and outputs an operation signal corresponding to the content of the operation input to the display control device 2.

### (Configuration of Display Control Device)

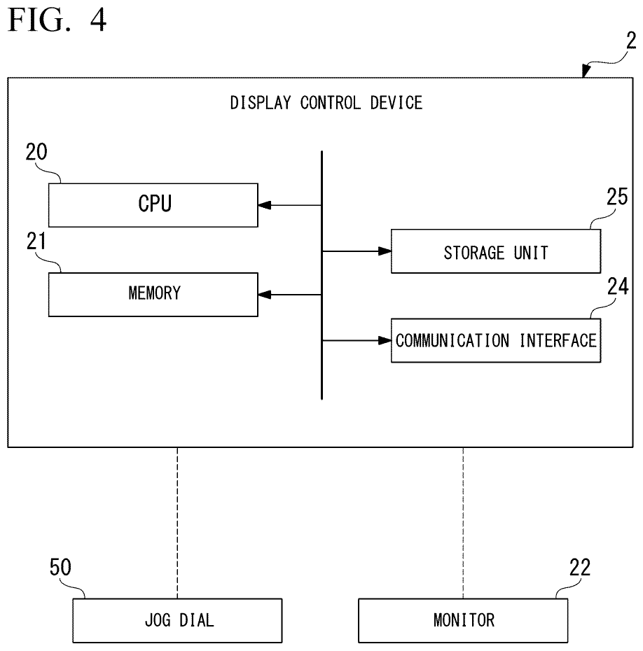

FIG. 4 is a diagram showing a hardware configuration of a control device according to the embodiment of the present disclosure.

Hereinafter, a function of the display control device 2 will be described in detail.

As shown in FIG. 4, the monitor 22 and the jog dial 50 are connected to the display control device 2 via an in-vehicle network such as a controller area network (CAN). The display control device 2 may be accommodated, for example, within the housing of the monitor 22.

The display control device 2 includes a CPU 20, a memory 21, a communication interface 24, and a storage unit 25. The CPU 20 may be of any aspect as long as it is similar to an FPGA, a GPU, or the like.

The CPU 20 is a processor that controls an overall operation of the display control device 2. Various functions included in the CPU 20 will be described later.

The memory 21 is a so-called main storage device. Instructions and data necessary for the CPU 20 to operate based on a program are loaded in the memory 21.

The communication interface 24 is a communication interface for communicating between the monitor 22, the jog dial 50, and an external server.

The storage unit 25 is a so-called auxiliary storage device and is a storage device such as a hard disk drive (HDD) or a solid-state drive (SSD).

In another embodiment, the display control device 2 may include a custom large scale integrated circuit (LSI) such as a programmable logic device (PLD) in addition to the configuration or instead of the configuration. Examples of PLDs include a programmable array logic (PAL), a generic array logic (GAL), a complex programmable logic device (CPLD), and a field programmable gate array (FPGA). In this case, some or all of the functions to be realized by the processor may be realized by the integrated circuit.

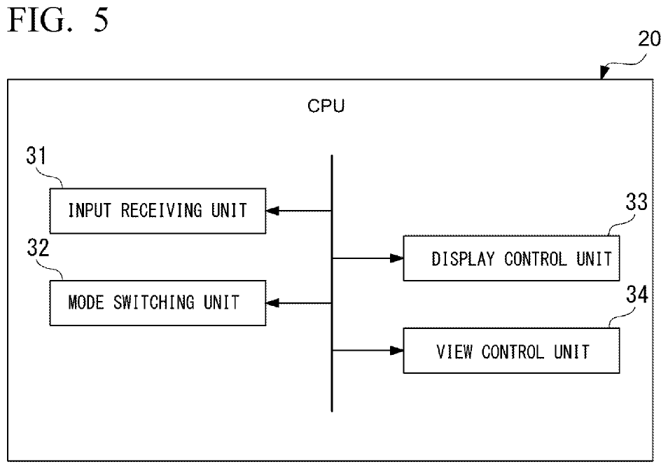

FIG. 5 is a diagram showing a functional configuration of the display control device according to the embodiment of the present disclosure.

As shown in FIG. 5, the CPU 20 functionally includes an input receiving unit 31, a mode switching unit 32, a display control unit 33, and a view control unit 34 by operating based on a predetermined program. The predetermined program may realize some functions exhibited by the display control device 2. For example, the program may exhibit the functions in combination with another program stored in advance in the storage unit 25, or in combination with another program mounted on another device.

The input receiving unit 31 receives an operation input from the jog dial 50. When the input receiving unit 31 receives the operation input via the operator with respect to any of the dial 51 and the first button 52 to the fourth button 55 of the jog dial 50, the input receiving unit 31 receives the input of the operation signal corresponding to the content of the operation input which is output from the jog dial 50.

The display control unit 33 controls the information displayed on the guidance screen Z according to the operation input performed with the jog dial 50. The display control unit 33 generates a display signal for displaying the guidance screen Z on the monitor 22.

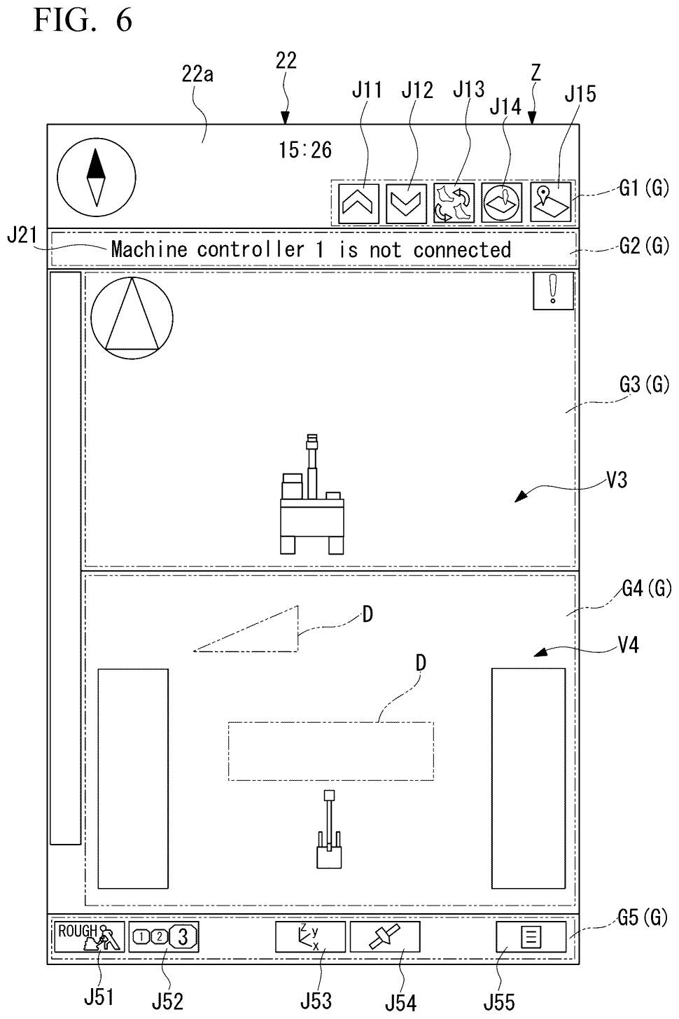

FIG. 6 is a diagram showing an example of a guidance screen displayed in a display region of a monitor according to the embodiment of the present disclosure.

The storage unit 25 stores information that is related to a plurality of group regions G set on the guidance screen Z and a plurality of icons J11 to J15 and J51 to J55 and alarm information J21, which are disposed as item information in each of the plurality of group regions G.

As shown in FIG. 6, the guidance screen Z is displayed in the display region 22a of the monitor 22 based on the signal generated by the display control unit 33. The plurality of group regions G are set on the guidance screen Z, for example. The plurality of group regions G are set by dividing the display region 22a into a plurality of regions. In the present embodiment, five group regions G1 to G5 are set on the guidance screen Z, for example. Each group region G is set to be selectable by performing a predetermined operation with the jog dial 50.

The plurality of icons J11 to J15, which are item information, are disposed in the group region G1 set in the upper portion of the guidance screen Z. A predetermined function is assigned to each of the plurality of icons J11 to J15. The plurality of icons J11 to J15 can be selected by operating the jog dial 50. In a case where each of the plurality of icons J11 to J15 is selected by the operation of the jog dial 50, the CPU 20 executes processing to implement a predetermined function assigned in advance.

For example, the alarm information J21 is displayed in the group region G2 as item information. The alarm information J21 is used, in a case such that when any abnormality occur according to the state of the work machine 1, or the like, to notify the operator of the content thereof. In a case where the operator selects the alarm information J21 by operating the jog dial 50, for example, detailed information or the like on the occurred abnormality may be displayed.

View images V3 and V4 related to the state of the work machine 1 are displayed in the group regions G3 and G4. For example, the state of the work machine 1 is displayed in the view images V3 and V4.

The view images V3 and V4 displayed in the group regions G3 and G4 display, as the state of the work machine 1, for example, the operation state of the movable part of the work machine 1. As the view images V3 and V4, for example, a side view, a top view, a front view, and a 3D screen can be displayed. The side view is an image showing a state in which a vehicle body of the work machine 1 and its surrounding terrain are viewed from the side. The top view is an image showing a state in which a vehicle body of the work machine 1 and its surrounding terrain are viewed from the top. The front view is an image showing a state in which the bucket BK of the work machine 1 and its surrounding terrain are viewed from the operator seated on the seat ST. The 3D screen is an image that displays the vehicle body of the work machine 1 and its surrounding terrain as a three-dimensional image. The display control unit 33 displays, as the view images V3 and V4 displayed in the group region G3, one of the side view, the top view, the front view, and the 3D screen, whichever is selected by the operation of the jog dial 50. In addition, the viewpoint (direction of the line of sight) in the view images V3 and V4 can be changed by operating the jog dial 50.

As shown in FIG. 6, the view image V4 displayed in the group region G4 displays, as the state of the work machine 1, for example, information indicating the positional relationship between the work machine 1 and the surrounding terrain (design surface).

The position of the work machine 1 is acquired via the GNSS antennas N1 and N2, the communication interface 24, and the like. Here, the information indicating the position of the work machine 1 is three-dimensional coordinate information indicated in a global coordinate system.

The design surface, which is terrain data acquired as three-dimensional data, is recorded in advance in the storage unit 25. The display control unit 33 displays the surrounding terrain of the work machine 1 in the view image V4 based on the terrain data and the position measurement information of the work machine 1 based on the GNSS antennas N1 and N2. The surrounding terrain includes information on a construction surface D constructed by the work machine 1. The information on the construction surface D includes coordinate information for specifying the construction surface D, or the like.

The surrounding terrain displayed in the view image V4 can be enlarged or reduced by operating the jog dial 50. In addition, the construction surface D displayed in the view image V4 can be selected by operating the jog dial 50. In a case where the specific construction surface D is selected by the operation of the jog dial 50, various types of information regarding the construction surface D may be displayed.

The plurality of icons J51 to J55, which are item information, are disposed in the group region G5. A predetermined function is assigned to each of the plurality of icons J51 to J55. The plurality of icons J51 to J55 can be selected by operating the jog dial 50. In a case where each of the plurality of icons J51 to J55 is selected by the operation of the jog dial 50, a predetermined function assigned in advance is performed.

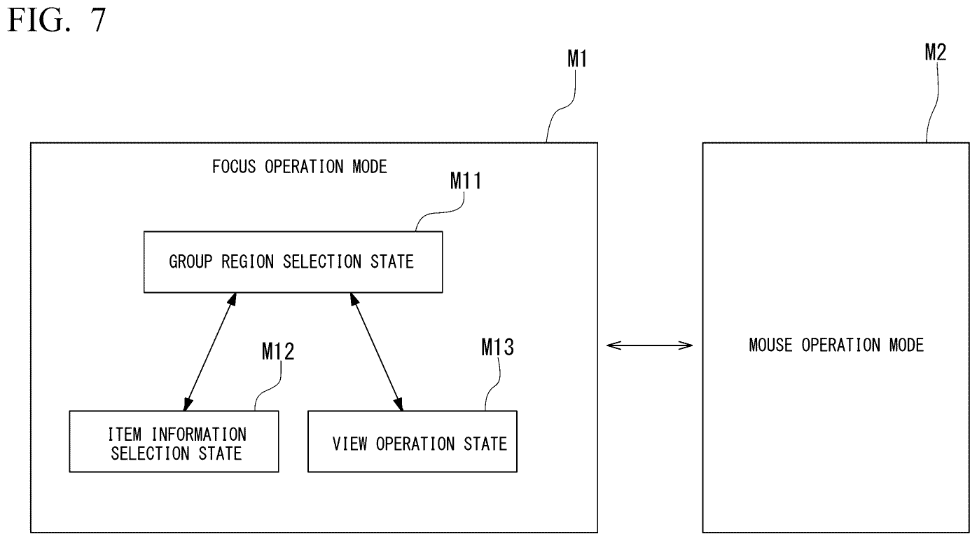

FIG. 7 is a diagram schematically showing transition of an operation mode in the display control device according to the embodiment of the present disclosure.

The mode switching unit 32 switches the operation mode on the guidance screen Z displayed in the display region 22a based on the operation input from the jog dial 50 received by the input receiving unit 31. The mode switching unit 32 alternately switches between a focus operation mode M1 and a mouse operation mode M2 based on the operation input from the jog dial 50, as shown in FIG. 7. In the present embodiment, for example, the fourth button 55 is pressed to switch between the focus operation mode M1 and the mouse operation mode M2.

### (Description of Focus Operation Mode)

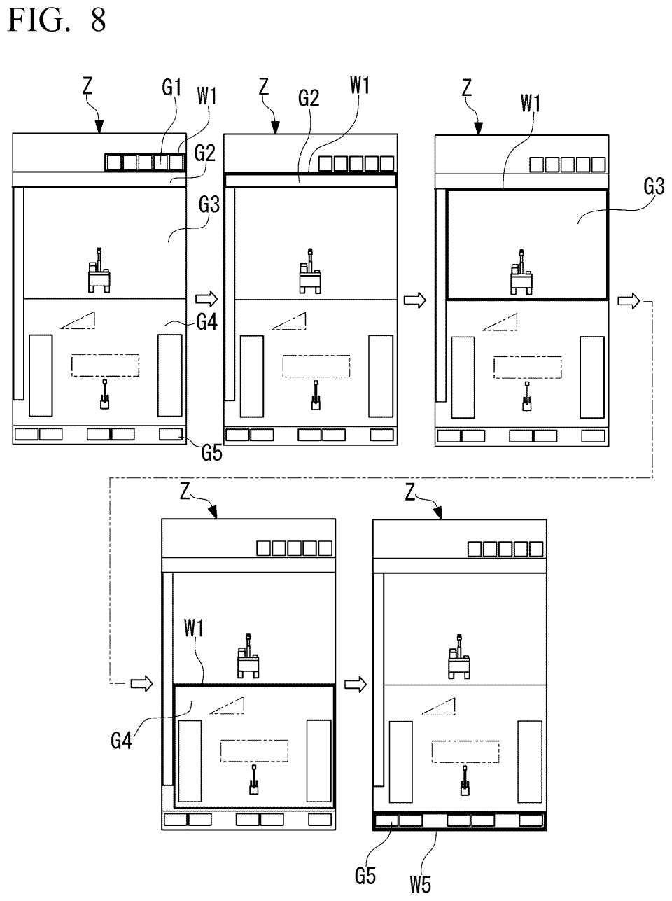

FIG. 8 is a diagram schematically showing transition of a selection state of a group region in the display control device according to the embodiment of the present disclosure.

In the focus operation mode M1, first, a state transitions to a group region selection state M11. In the group region selection state M11, one of the plurality of group regions G1 to G5 can be selected. In the group region selection state M11, the plurality of group regions G1 to G5 displayed on the guidance screen Z are sequentially selected by operating the jog dial 50. In the present embodiment, the group regions G1 to G5 are sequentially selected by the rotation operation of the dial 51. As shown in FIG. 8, for example, when the dial 51 is rotated rightward that is clockwise, the group regions G1 to G5 are selected in the order of group regions G1→G2→G3→G4→G5. In addition, when the dial 51 is rotated leftward that is counterclockwise, the group regions G1 to G5 are selected in the order of group regions G5→G4→G3→G2→G1. In the display control unit 33, among the group regions G1 to G5, in order to focus on the one selected by the operation of the dial 51, the selected one is highlighted, for example, by displaying a selection frame W1. Highlighting may also be performed by changing the display color, changing the display brightness, or the like.

In the group region selection state M11, when any one of the group regions G1 to G5 is selected and, for example, the dial 51 is pressed, the mode switching unit 32 causes the state to transition to an item information selection state M12 or a view operation state M13.

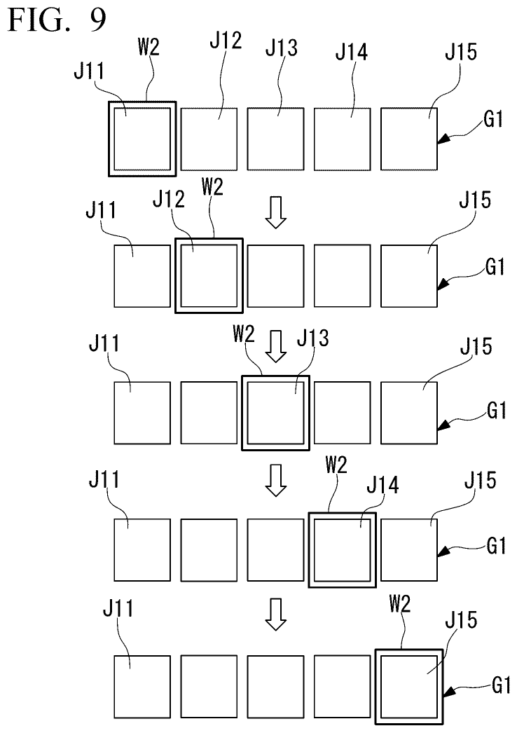

FIG. 9 is a diagram schematically showing transition of selection states of a plurality of icons in the display control device according to the embodiment of the present disclosure.

In the focus operation mode M1, when the dial 51 is pressed while any of the group regions G1, G2, and G5 is selected, the state transitions to the item information selection state M12.

In the item information selection state M12, for example, when the group region G1 is selected, one of the icons J11 to J15 disposed in the selected group region G1 is in a selectable state. As shown in FIG. 9, in the item information selection state M12, the icons J11 to J15 are sequentially selected by operating the jog dial 50. In the present embodiment, the icons J11 to J15 are sequentially selected by the rotation operation of the dial 51. For example, when the dial 51 is rotated rightward that is clockwise, the icons J11 to J15 are selected in the order of icons J11→J12→J13→J14→J15. In addition, when the dial 51 is rotated leftward that is counterclockwise, the icons J11 to J15 are selected in the order of icons J15→J14→J13→J12→J11. In the display control unit 33, among the icons J11 to J15, in order to focus on the one selected by the operation of the dial 51, the selected one is highlighted, for example, by displaying a selection frame W2. Highlighting may also be performed by changing the display color, changing the display brightness, or the like.

In the item information selection state M12, when any one of the icons J11 to J15 is selected and, for example, the dial 51 is pressed, the CPU 20 executes the required function assigned to the selected icon J11 to J15.

In the item information selection state M12, for example, when the group region G2 is selected, for example, transition to displaying the detailed information of the alarm information J21, or the like is performed via the press operation of the dial 51.

In addition, in the item information selection state M12, for example, when the group region G5 is selected, the rotation operation and the press operation of the dial 51 are sequentially performed, as the same as in the case of the group region G1, to select any one of the icons J51 to J55, and the CPU 20 executes the required function.

In addition, in the item information selection state M12, for example, when the first button 52 is pressed, the state returns to the group region selection state M11.

In the focus operation mode M1, when the dial 51 is pressed while the group regions G3 and G4 are selected, the state transitions to the view operation state M13.

In the view operation state M13, for example, when the group region G3 is selected, the view image V3 displayed in the selected group region G3 transitions to an active state via the view control unit 34. The active state refers to a state in which an operation via the jog dial 50 is possible with respect to the view image V3. For example, when the dial 51 is tilted forward, the view control unit 34 moves the viewpoint of the view image V3 upward. In addition, when the dial 51 is tilted backward, the view control unit 34 moves the viewpoint of the view image V3 downward. When the dial 51 is tilted leftward, the view control unit 34 moves the viewpoint of the view image V3 leftward. When the dial 51 is tilted rightward, the view control unit 34 moves the viewpoint of the view image V3 rightward.

In addition, for example, when the dial 51 is rotated rightward, the view control unit 34 enlarges the view image V3. When the dial 51 is rotated leftward, the view control unit 34 reduces the view image V3.

In addition, for example, the view image V3 can be sequentially switched between the side view, the top view, the front view, and the 3D screen by pressing the first button 52 and the second button 53.

In the view operation state M13, for example, when the group region G4 is selected, the view control unit 34 causes the view image V4 displayed in the selected group region G4 to transition to an active state. The active state refers to a state in which an operation via the jog dial 50 is possible with respect to the view image V4.

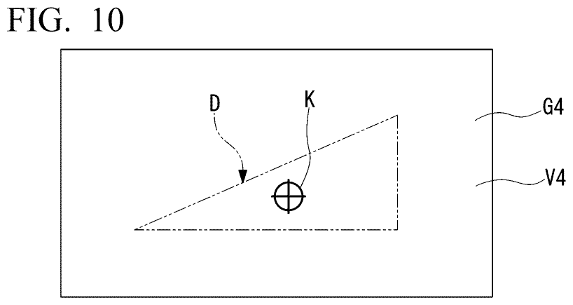

FIG. 10 is a diagram schematically showing transition of a display state of a view image in the display control device according to the embodiment of the present disclosure.

As shown in FIG. 10, in the view operation state M13, a reference marker K is displayed at a predetermined position on the view image V4. For example, when the dial 51 is tilted forward, the view control unit 34 moves the region of the surrounding terrain displayed in the view image V4 upward with the reference marker K as the center. In addition, when the dial 51 is tilted backward, the view control unit 34 moves the region of the surrounding terrain displayed in the view image V4 downward with the reference marker K as the center. When the dial 51 is tilted leftward, the view control unit 34 moves the region of the surrounding terrain displayed in the view image V4 leftward with the reference marker K as the center. When the dial 51 is tilted rightward, the view control unit 34 moves the region of the surrounding terrain displayed in the view image V4 rightward with the reference marker K as the center.

In addition, when the display region of the surrounding terrain is adjusted with the reference marker K as a reference by tilting the dial 51 as appropriate and the dial 51 is pressed while the reference marker K is superimposed on the construction surface D, the view control unit 34 can display various types of information related to the construction surface D.

In addition, for example, when the dial 51 is rotated rightward, the view control unit 34 enlarges the view image V4. When the dial 51 is rotated leftward, the view control unit 34 reduces the view image V4.

In addition, in the view operation state M13, for example, when the first button 52 is pressed, the state returns to the group region selection state M11.

### (Description of Mouse Operation Mode)

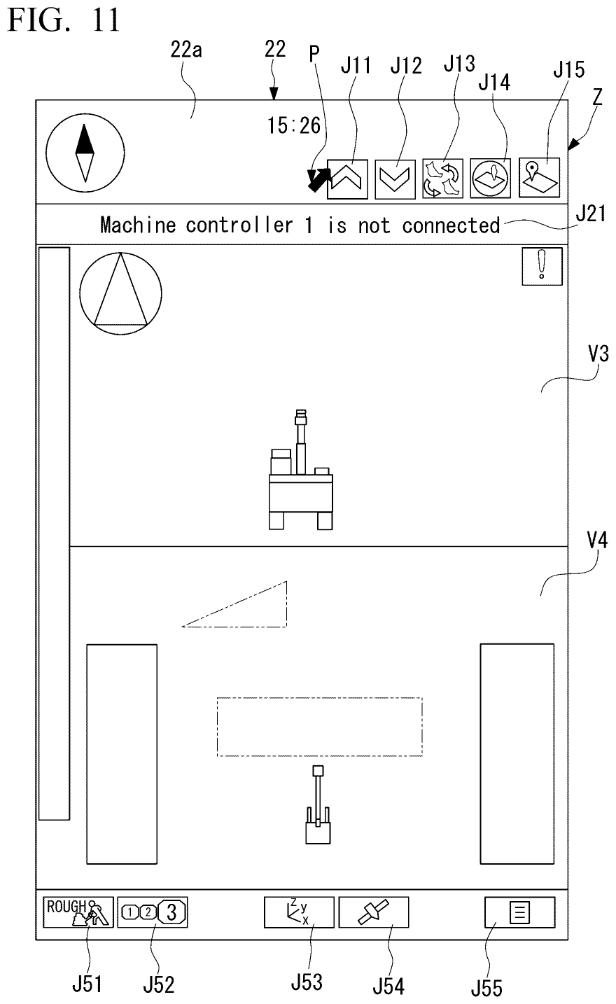

FIG. 11 is a diagram schematically showing the mouse operation mode in the display control device according to the embodiment of the present disclosure.

As shown in FIG. 11, in the mouse operation mode M2, the display control unit 33 displays a mouse cursor P on the guidance screen Z displayed in the display region 22a.

In the mouse operation mode M2, the display control unit 33 moves the position of the mouse cursor P on the guidance screen Z in response to the operation of the jog dial 50.

For example, when the dial 51 is tilted forward, the display control unit 33 moves the mouse cursor P upward on the guidance screen Z. When the dial 51 is tilted backward, the display control unit 33 moves the mouse cursor P downward. When the dial 51 is tilted leftward, the display control unit 33 moves the mouse cursor P leftward. When the dial 51 is tilted rightward, the display control unit 33 moves the mouse cursor P rightward. As described above, in the mouse operation mode M2, a direct operation is possible on the display region 22a in response to the operation via the jog dial 50.

In the mouse operation mode M2, the item information displayed in all the plurality of group regions G, that is, any one of the icons J11 to J15 and J51 to J55, can be directly selected by operating the mouse cursor P using the jog dial 50.

For example, in the mouse operation mode M2, when the dial 51 is pressed while the mouse cursor P is superimposed on any one of the icons J11 to J15 and J51 to J55, the CPU 20 executes the required function assigned to the selected icon.

In addition, in the mouse operation mode M2, when the dial 51 is pressed while the mouse cursor P is superimposed on the alarm information J21, the CPU 20 executes the display of the detailed information of the alarm information J21, or the like.

In addition, when the dial 51 is pressed while the mouse cursor P is superimposed on any one of the view images V3 and V4, the view image V3 or the view image V4 on which the mouse cursor P is superimposed can also be set in an active state.

### (Processing Flow of Control Device)

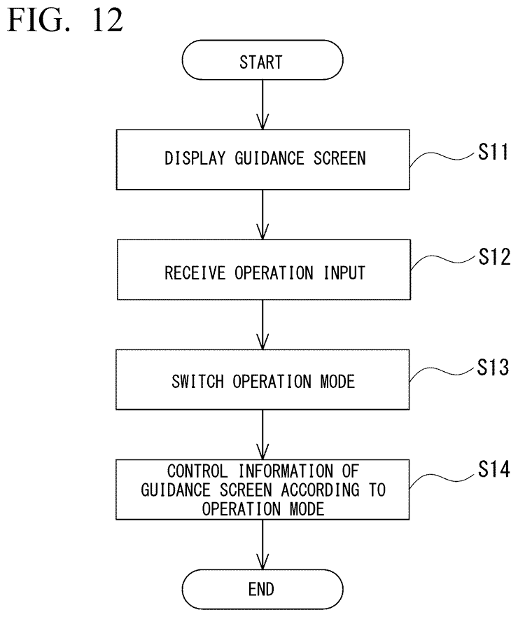

FIG. 12 is a diagram showing a processing flow of the display control device according to the embodiment of the present disclosure.

The processing flow shown in FIG. 12 is executed after power is applied to the display control device 2 by the operator. The display control device 2 may be automatically started when the power of the work machine 1 is applied thereto.

First, the CPU 20 displays the guidance screen Z regarding the work machine 1 in the display region 22a of the monitor 22 (step S11). After that, when the input receiving unit 31 receives the operation input from the jog dial 50 provided in the cab 12A of the work machine 1 (step S12), the mode switching unit 32 switches the operation mode of the jog dial 50 on the display region 22a between the focus operation mode M1 and the mouse operation mode M2 based on the operation input (step S13). Next, the display control unit 33 controls the information of the guidance screen Z displayed in the display region 22a according to the operation input from the jog dial 50 based on the switched operation mode (step S14).

### Operations and Effects

According to the present embodiment, it is possible to improve operability of the display control device 2 and to reduce a load on the operator.

Hereinbefore, the embodiment of the present invention has been described with reference to the drawings. However, a specific configuration is not limited to the embodiment described above, and includes design changes and the like without departing from the gist of the present invention.

In the embodiment described above, examples of various operations on the jog dial 50 have been described, but the functions assigned to the dial 51 and the first button 52 to the fourth button 55 of the jog dial 50 can be changed as appropriate.

In addition, in the embodiment described above, an example of the guidance screen Z is shown, but the display content on the guidance screen Z can be changed as appropriate.

In the above-described embodiment, the monitor 22 need not be of the touch panel type.

In the above-described embodiment, the work machine 1 is a hydraulic excavator, but is not limited thereto. For example, the work machine 1 according to another embodiment may be another work machine such as a dump truck, a bulldozer, or a wheel loader.

In addition, a part or all of a program executed by a computer in the embodiments described above can be distributed via a computer-readable recording medium or a communication line.

### INDUSTRIAL APPLICABILITY

According to each aspect of the present disclosure, it is possible to improve operability and reduce a load on an operator.

### REFERENCE SIGNS LIST

1: Work machine
2: Display control device
22: Monitor
22a: Display region
25: Storage unit
31: Input receiving unit
32: Mode switching unit
33: Display control unit
34: View control unit
50: Jog dial
D: Construction surface
G, G1 to G5: Group region
J11 to J15, J51 to J55: (item information)
J21: Alarm information (item information)
K: Reference marker
M1: Focus operation mode
M2: Mouse operation mode
P: Mouse cursor
ST: Seat (driver's seat)
V3, V4: View image
Z: Guidance screen

1. A display control device that displays information related to a work machine in a display region of a monitor provided in the work machine, the display control device comprising:
a storage unit configured to store a plurality of group regions set by dividing the display region and one or more pieces of item information disposed in each of the plurality of group regions and in which a predetermined function is assigned;
an input receiving unit configured to receive an operation input from an operation input unit provided in a driver's seat of the work machine;
a mode switching unit configured to enable switching of an operation mode on the display region based on the operation input from the operation input unit received by the input receiving unit; and
a display control unit configured to control information to be displayed on a guidance screen according to the operation input that is input to the input receiving unit based on the operation mode switched by the mode switching unit,
wherein the mode switching unit enables switching between a focus operation mode in which one of the plurality of group regions is selectable and a mouse operation mode in which a direct operation is possible on the display region.

2. The display control device according to claim 1,
wherein, in the focus operation mode, when any one of the plurality of group regions is selected, the one or more pieces of item information disposed in the selected group region are in a selectable state, and,
in the mouse operation mode, the item information displayed in all the plurality of group regions on the display region is directly selectable via the operation input from the operation input unit.

3. The display control device according to claim 1,
wherein the operation input unit is a jog dial, and
the mode switching unit switches between the focus operation mode and the mouse operation mode based on an operation input from the jog dial.

4. The display control device according to claim 1,
wherein, in the focus operation mode, when any one of the plurality of group regions and the pieces of item information on the guidance screen is selected based on the operation input that is input to the input receiving unit, the display control unit highlights the selected group region or the selected item information.

5. The display control device according to claim 1,
wherein, in the mouse operation mode, the display control unit displays a mouse cursor in the display region and moves the mouse cursor in the display region based on the operation input that is input to the input receiving unit to make any one of the pieces of item information selectable.

6. The display control device according to claim 1,
wherein a view image related to a state of the work machine is displayed in the group region, and
the display control device further comprises a view control unit configured to make at least one of an enlargement/reduction operation of the view image, a viewpoint switching operation of the view image, and a selection operation of a construction surface via the work machine executable based on the operation input that is input to the input receiving unit when the group region in which the view image is displayed is selected.

7. The display control device according to claim 6,
wherein the view control unit displays a reference marker that serves as a reference point on the view image when the group region in which the view image is displayed is selected.

8. A work machine comprising:
the display control device according to claim 1.

9. A display control method for a monitor provided in a work machine, the display control method comprising the steps of:
displaying information related to the work machine in a display region of the monitor;
receiving an operation input from an operation input unit provided in a driver's seat of the work machine;
switching an operation mode via the operation input unit on the display region based on the operation input; and
controlling the information displayed in the display region according to the operation input based on the switched operation mode,
wherein, in the step of switching the operation mode, switching between a focus operation mode in which one of a plurality of group regions set by dividing the display region is selectable and a mouse operation mode in which a direct operation is possible on the display region is enabled.

10. The display control device according to claim 2,
wherein, in the focus operation mode, when any one of the plurality of group regions and the pieces of item information on the guidance screen is selected based on the operation input that is input to the input receiving unit, the display control unit highlights the selected group region or the selected item information.

11. The display control device according to claim 3,
wherein, in the focus operation mode, when any one of the plurality of group regions and the pieces of item information on the guidance screen is selected based on the operation input that is Preliminary Amendment input to the input receiving unit, the display control unit highlights the selected group region or the selected item information.

12. The display control device according to claim 2,
wherein, in the mouse operation mode, the display control unit displays a mouse cursor in the display region and moves the mouse cursor in the display region based on the operation input that is input to the input receiving unit to make any one of the pieces of item information selectable.

13. The display control device according to claim 3,
wherein, in the mouse operation mode, the display control unit displays a mouse cursor in the display region and moves the mouse cursor in the display region based on the operation input that is input to the input receiving unit to make any one of the pieces of item information selectable.

14. The display control device according to claim 2,
wherein a view image related to a state of the work machine is displayed in the group region, and
the display control device further comprises a view control unit configured to make at least one of an enlargement/reduction operation of the view image, a viewpoint switching operation of the view image, and a selection operation of a construction surface via the work machine executable based on the operation input that is input to the input receiving unit when the group region in which the view image is displayed is selected.

15. The display control device according to claim 2,
wherein a view image related to a state of the work machine is displayed in the group region, and
the display control device further comprises a view control unit configured to make at least one of an enlargement/reduction operation of the view image, a viewpoint switching operation of the view image, and a selection operation of a construction surface via the work machine executable based on the operation input that is input to the input receiving unit when the group region in which the view image is displayed is selected.

16. The display control device according to claim 3,
wherein a view image related to a state of the work machine is displayed in the group region, and
the display control device further comprises a view control unit configured to make at least one of an enlargement/reduction operation of the view image, a viewpoint switching operation of the view image, and a selection operation of a construction surface via the work machine executable based on the operation input that is input to the input receiving unit when the group region in which the view image is displayed is selected.

17. The display control device according to claim 15,
wherein the view control unit displays a reference marker that serves as a reference point on the view image when the group region in which the view image is displayed is selected.

18. The display control device according to claim 16,
wherein the view control unit displays a reference marker that serves as a reference point on the view image when the group region in which the view image is displayed is selected.

19. A work machine comprising:
the display control device according to claim 2.

20. A work machine comprising:
the display control device according to claim 3
